(19) United States
(12) Patent Application Publication
(10) Pub. No.: US 2007/0266517 A1
(43) Pub. Date: Nov. 22, 2007

(54) Automotive wiper assembly

(75) Inventors: In Kyu Kim, Ansan-Si (KR); Kyung Su Kim, Ansan-Si (KR); Tae Young Kim, Ansan-Si (KR); Kyung Jong Nam, Jung-Gu (KR); Hwa Seong Kim, Ansan-Si (KR)

Correspondence Address: SUGHRUE MION, PLLC, 2100 PENNSYLVANIA AVENUE, N.W., SUITE 800, WASHINGTON, DC, 20037, US

(73) Assignee: ADM 21 CO., LTD

(21) Appl. No.: 11/783,089

(22) Filed: Apr. 5, 2007

Related U.S. Application Data
(63) Continuation-in-part of application No. 29/257,251, filed on Apr. 3, 2006, now Pat. No. D552025.

(30) Foreign Application Priority Data
Oct. 4, 2005 (KR) 30-2005-0033448

(51) Int. Cl. B60S 1/40; B60S 1/38

(52) U.S. Cl. 15/250.29; 15/250.361; 15/250.43

(57) ABSTRACT

A vehicle wiper blade and wiper blade assembly having a longitudinal stiffener mounted on the blade body at an offset angle from the central geometric plane of the blade edge, defined by the neck and wiping edge of the blade. When mounted in the presence of a wind stream flowing over the vehicular windshield, the protruding face surfaces of the stiffener function as an air dam to reduce lift-off effects, or as an airfoil to provide a supplemental pressure directing the wiper blade against the windshield. The proximity of the lower, forward edge of the blade to the windshield serves as an air dam. The upper trailing edge of the blade may be extended to serve as an airfoil. Torque about the wiping edge is avoided by directing the wiper arm pressing force in alignment with the central geometric plane of the blade, and preferably through the neck portion of the blade.

This application is a Continuation-in-part of U.S. application Ser. No. 29/257,251, filed on Apr. 3, 2006, and claims priority to the Republic of Korea application 30-2005-0033448, filed Oct. 4, 2005, the disclosures of which are incorporated herein.

### FIELD OF THE INVENTION

Embodiments of the invention relate to wiper blades for removing water from the windshields of vehicles. More particularly, the invention encompasses a wiper blade assembly designed to accommodate a high-speed airflow over a vehicle windscreen.

### BACKGROUND OF THE INVENTION

An automotive windshield wiper removes water from a car windshield. It is operated by a wiper motor and mechanical linkages that move a wiper arm back and forth in a predetermined arc. At its end, the wiper arm carries a wiper blade. Along a portion of the arc, when the wiper blade is elevated and generally in line with the direction of airflow passing over the windshield, the airflow has a reduced tendency to lift the blade off of the windshield. Along another part of the arc, when the wiper blade is near even to the horizontal plane, the airflow has a greater tendency to lift the wiper blade off of the windshield. This effect, particularly at high speeds, can reduce the effectiveness of the wiper blade in removing water from the windshield.

Conventional detachable wiper blades are secured to mechanically actuated wiper arms at the end of the wiper arm. The free end of the wiper arm may be provided with a transverse pin or a hook for engagement with the blade or with a connector that, in turn, engages with the blade or a blade assembly.

Some blade assemblies include a skeletal frame that carries the wiper blade. When a skeletal frame is employed as part of the blade assembly, it often includes a first arcuate link of a length that is approximately half the length of the rubber blade, and two shorter, secondary links carried at the respective ends of the first arcuate link. The ends of the two shorter links are connected at four locations to the flat stiffener that is inter-fitted with the rubber blade, distributing the force being applied to the blade. The links in the skeletal frame are approximately symmetrically arranged with respect to the length of the rubber blade. The longer, first, arcuate link is fitted to the end of the wiper arm at its center point with the object of balancing the distributed force supplied by the wiper arm to the rubber blade. Other skeletal forms may be employed as well. Such frames, as well as connectors that directly engage the end of the wiper arm, generally connect to the stiffener that is coupled to the rubber blade.

With or without the presence of a skeletal frame, the blade portion of a standard wiper, generally made of rubber, has mounted into it a flat, two dimensional strip stiffener, generally made of steel. The body of the wiper blade above the neck in many cases incorporates lateral grooves that are interfitted with the stiffener.

The stiffener is substantially rigid in the directions lateral to its longitudinal extent and parallel to the surface of the windshield. But in a plane upright to the windshield, the stiffener is generally soft enough to comply with the window-directed force applied by the wiper arm, but stiff enough to distribute this force along the blade. The stiffener is substantially constrained by its aspect ratio to bend preferably within a plane aligned with the perpendicular extending outwardly from the upper and lower surfaces of the stiffener. Hereafter, this is referred to as the “bending plane of the stiffener”.

The stiffener and wiper blade have complementary slots that allow them to inter-fit with each other. In the absence of a skeletal frame, a blade may be attached directly to the end of the wiper arm by connection to the sides of the stiffener or so connected through a connector. Such a latter wiper configuration may be characterized as a “beam” blade.

The stiffener, in almost all blades as well as in a beam blade, is typically made of steel, and can function as a leaf spring. The stiffener is flexible, and when functioning as a spring, may be formed to assume a natural curvature when free of any external applied force. A specific curvature may be induced to improve the uniformity of the force with which the rubber blade is applied to a windshield. This is particularly appropriate when the windshield may have a degree of curvature but is also relevant to obtain a preferred, generally even distribution of the pressing force of the blade along the full length of blade. The source of the applied force is the wiper arm, which is generally spring-loaded to press the wiper blade against the windshield.

A common rubber wiper blade has a pair of grooves running lengthwise along the lateral sides of the length of the blade which provides a means for coupling the stiffener to the blade. The stiffener has a central slot bounded by two respective sides of the stiffener. The slot is dimensioned to permit, with manipulation, the stiffener to engage the rubber blade with the two respective sides of the stiffener nested in the two lateral slots on the blade while, at the same time, the central spine of the blade lies within the central slot in the stiffener.

In order to reduce the tendency of a wiper blade to lift-off or shudder under the influence of a high velocity wind stream, the blade, or blade assembly further comprise airfoils. Airfoils utilize the force of a wind stream to increase the tendency of the wiper blade to press against the windshield. This effect is particularly appropriate when the wiper blade is in a more nearly horizontal orientation. Such airfoils have been deployed both as part of the blade assembly holding a rubber blade and on the rubber blade itself.

As mentioned previously, the wiper arm is spring-loaded to direct the free, distal end of the wiper arm towards the windshield. When a wiper blade incorporating a stiffener, with or without a blade support assembly, is fitted to the end of the wiper arm, the wiper arm applies a pressing force which is transmitted through to the wiper blade, urging the wiper blade to press against the windscreen.

Generally, the connection between the wiper blade and the end of the wiper arm is made approximately around the center region of the length of the wiper blade. This contributes to a relatively balanced distribution of the pressing force along the length of the wiper blade. This same connection can apply the pressing force to the wiper blade, if so arranged, in a direction that is offset from the wiper edge of the blade so as to generate a torque that tends to rotate the wiper blade about its longitudinal axis. This torque is resisted by the coupling between the blade and the end of the wiper arm, which may be relatively stiff. Consequently, the greater part of the response to this torque occurs within the rubber wiper blade itself.

Before contacting a windshield, the arrowhead portion of the wiping edge is generally presented to a windshield in an upright, near-perpendicular orientation. The arrowhead cross-section portion of the blade will tend to bend about the neck as the blade edge is wiped across the windshield, with the blade edge trailing. By minimizing the presence of any torque arising from the pressing force, the tendency to develop blade edge deflection significantly beyond the limit arising from contact between the arrowhead and blade body portion can be held to similar values irrespective whether the blade edge is being wiped in a first or second, reverse direction.

Connectors have also been articulated to allow wiper blades to rotate not only about an axis that is transverse to its longitudinal length, but also to provide freedom for a blade to swivel sideways, about an axis parallel to such longitudinal length. Further, connectors have been offset or angled so as to shift the position of the wiping edge laterally from alignment with the center of force applied by the end of the wiper arm.

The present invention provides a wiper blade and wiper blade assembly that advantageously resists the action of a wind stream in lifting the blade off a windshield when the automobile is traveling at high speeds, while also providing a wiper blade that is easy to fabricate and readily adaptable to existing wiper blade installation systems.

### SUMMARY OF THE INVENTION

One embodiment of the invention encompasses a windshield wiper blade assembly including:

a flexible blade body having an upper body portion and a lower wiping edge portion, where said wiping edge portion is supported from the body portion by an edge support portion, the edge support portion being connected to the body portion through a neck portion,

a pair of lateral longitudinal mounting slots,

a stiffener engaged with said mounting slots, and

wherein the mounting slots are inclined at an offset angle from the central geometric plane of the blade.

The stiffener may have two top face surface portions that protrude outwardly from both of the lateral sides of the wiper blade.

The upper body portion may have a top surface, and the top surface is generally parallel with a top face surface portion of the stiffener.

According to one embodiment, at least one edge of the extending face surfaces of the stiffener is tapered and narrows towards the end of the blade.

A lateral side of the stiffener may be more narrow at a center portion of the wiper blade than on either side of such center portion.

In the windshield wiper blade assembly according to one embodiment, the upper body portion of the wiper blade has a rearward, downstream lateral face with a longitudinal groove formed in the rearward face, running the length of the blade.

The orientation of the stiffener at an offset angle from the central geometric plane of the blade defines an asymmetry in the blade, the wiping blade is in combination with a connector for engagement to the end of a wiper arm on a motor vehicle. The connector engages the wiper blade by connecting to the extending sides of the stiffener, the connector is asymmetrically formed to cancel the effect of the asymmetry in the orientation of the stiffener within the wiper blade so as to present the wiping edge of the wiper blade, when coupled to the wiper arm, to a windshield with a normal, substantially upright, vertical, orientation with the central plane of the wiper in a generally upright orientation with respect to the windshield.

The windshield wiper blade may further comprise a connector means for engagement to the end of a wiper arm on a motor vehicle, wherein the connector engages the wiper blade by connecting to the extending sides of the stiffener, the connector is geometrically formed to engage the blade so that the line of force generated by the pressure of the end of a wiper arm on a vehicle windshield in the central portion of the blade and lies within or generally proximate and parallel to the central plane of the blade.

The stiffener may be in the form of a leaf spring that has a preset curvature intended to complement the curvature of a windshield surface and to overcome a lack of rigidity in the stiffener, such curvature is greater towards the central portion of the wiper blade than on either side of the central portion.

Another embodiment of the invention encompasses a rubber blade for a wiper having a frame supporting the rubber blade that closely contacts a surface of an automotive windshield and being attached to a wiper arm for pressing and operating the wiper against and across the windshield via an adapter, and a tension spring having a predetermined tension and inserted along a mounting slot of the rubber blade for evenly distributing load along the blade onto the windshield, the rubber blade including: a head portion forming an upper portion of the rubber blade and including a mounting slot for mounting the rubber blade to the frame, the mounting slot being inclined at an offset angle dependant on a position of the frame such that a normal line of a cross section of the mounting slot is offset by a predetermined angle from a vertical axis of the rubber blade; and a wiping portion forming a lower portion of the rubber blade for contacting the windshield, the wiping portion being disposed in a direction of the vertical axis.

The wiper may further comprise an air pocket disposed on an upper side of the rubber blade for imparting added deforming and recovering elasticity thereto.

Another embodiment of the invention encompasses a wiper frame having a predetermined resilience and a slot formed therein and coupled through an adaptor to a wiper arm, the wiper frame for supporting and pressing a rubber blade on a windshield surface, characterized in that the wiper arm moves the rubber blade across the windshield surface, the slot guides a sliding insert formed in a mounting portion at an upper end of the rubber blade for distributing a load from the wiper arm evenly across the rubber blade, the mounting portion is disposed at a predetermined angle against the wiper frame and supports a wiping portion forming a contact surface at a bottom end of the rubber blade, the slot is formed in a position such that a pressure of the wiper arm falls at a center point of the wiping portion, the slot allows the wiping portion to apply vertical force on and contact the windshield surface by being mounted on the frame through the mounting portion, and the slot creates a predetermined offset between centers of the mounting portion and the wiping portion.

The slot may be formed in a symmetric shape about a center of the wiper frame.

The slot may be formed with a curvature that curves gently toward both ends thereof.

Still another embodiment of the invention encompasses a rubber blade of a wiper mounted to a frame with a predetermined elasticity, characterized in that the frame evenly distributes a load along the rubber blade onto a windshield surface, the frame is coupled through an adapter to a wiper arm and presses the rubber blade against the windshield surface to simultaneously move the rubber blade across the windshield surface, the rubber blade has a sliding insert into which the frame is installed, the rubber blade has a top that is slanted and installed at a predetermined angle at a mounting portion of the rubber blade with respect to the frame, a lower end of the rubber blade has a wiping portion extending from the mounting portion and including a contact surface contacting the windshield surface, the mounting portion and the wiping portion are formed such that respective centers thereof are offset from one another by a predetermined distance such that a pressing force of the wiper arm passes through the center of the wiping portion.

The offset distance may be a distance between the center of the mounting portion and the center of the wiping portion.

The pressing force passes between the center of the wiping portion and the contact point through the offset.

Another embodiment of the invention encompasses an automotive wiper having a frame supporting a blade that closely contacts a surface of an automotive windshield and being attached to a wiper arm for pressing and operating the wiper against and across the windshield via an adapter, and a tension spring having a predetermined tension and inserted along a rail portion of the blade for evenly distributing load along the blade onto the windshield, wherein the automotive wiper includes: an adapter disposed perpendicularly to a longitudinal axis of the frame at a central portion thereof for a wiper arm to mount to, the frame being offset by an angle θ from a horizontal axis taken at a sectional view of the wiper with respect to the adapter, whereby the frame is offset by an adjustable angle θ1 from a perpendicular axis due to an offset of the frame and the adapter when the blade is pressed in its entirety against the automotive windshield.

The frame may include a leading edge that is disposed closer to the windshield than a trailing edge of the frame when the frame is pressed against the windshield, whereby the adapter and frame are selectively positioned at an offset angle of between 5° to 50° with respect to a vertical axis.

Another embodiment of the invention encompasses an automotive wiper having a frame supporting a blade that closely contacts a surface of an automotive windshield and being attached to a wiper arm for pressing and operating the wiper against and across the windshield via an adapter, and a tension spring having a predetermined tension and inserted along a rail portion of the blade for evenly distributing load along the blade onto the windshield, wherein the automotive wiper includes: a tensile member formed along one piece and extending symmetrically to both ends thereof from a central portion, the tensile member being both a single one-piece tension spring and a skeletal structure for mounting to a wiper arm; and an adapter disposed perpendicularly to a longitudinal axis of the tensile member at a central portion thereof for the wiper arm to mount to, the tensile member being offset by an angle θ from a horizontal axis taken at a sectional view of the wiper with respect to the adapter, whereby the tensile member is offset by an adjustable angle θ1 from a perpendicular axis due to an offset of the tensile member and the adapter when the blade is pressed in its entirety against the automotive windshield.

The tensile member may include a leading edge that is disposed closer to the windshield than a trailing edge of the tensile member when the tensile member is pressed against the windshield, whereby the adapter and tensile member are selectively positioned at an offset angle of between 5° to 50° with respect to a vertical axis.

The tensile member narrows toward each end thereof and has a recess at a central portion thereof for reducing negative pressure.

The blade mounted to the tensile member is laterally asymmetrical and offset from a vertical axis according to the offset angle of the tensile member.

The blade is curved and attached to the tensile member for maintaining a substantially vertical disposition of the blade with respect to the windshield and close contact with the windshield.

Still another embodiment of the invention encompasses an automotive wiper having a frame supporting a blade that closely contacts a surface of an automotive windshield and being attached to a wiper arm for pressing and operating the wiper against and across the windshield via an adapter, and a tension spring having a predetermined tension and inserted along a rail portion of the blade for evenly distributing load along the blade onto the windshield, wherein the automotive wiper includes: a tensile member formed along one piece and extending symmetrically to both ends thereof from a central portion, the tensile member being both a single one-piece tension spring and a skeletal structure for mounting to the wiper arm; and an adapter disposed perpendicularly to a longitudinal axis of the tensile member at a central portion thereof for the wiper arm to mount to, the tensile member being offset by an angle .theta. from a horizontal axis taken at a sectional view of the wiper with respect to the adapter, whereby the tensile member is offset by an adjustable angle θ1 from a perpendicular axis due to an offset of the tensile member and the adapter when the blade is pressed in its entirety against the automotive windshield, and whereby the blade is curved to deviate by an angle θ2 from a longitudinal axis thereof for maintaining a substantially perpendicular angle with respect to the windshield and close contact with the windshield, despite being offset from a vertical axis thereof in conjunction with the tensile member.

The tensile member that is a single piece wiper frame includes a leading edge that is disposed closer to the windshield than a trailing edge of the tensile member when the tensile member is pressed against the windshield, whereby the adapter and tensile member are selectively positioned at an offset angle of between 5° to 50° with respect to a vertical axis.

The tensile member narrows toward each end thereof and has a recess at a central portion thereof where the adapter is located.

One embodiment of the invention encompasses a windshield wiper blade including:

a rounded top portion,

a central body portion, and

a wiping edge portion,

wherein the rounded top portion is connected to the central body portion via a first neck portion,

wherein the central body portion is connected to the wiping edge portion via a second neck portion,

wherein the central body portion has a pair of mounting slots, and the wiping edge is in the shape of an arrow.

The blade may be made of a rubber material.

One embodiment of the present invention encompasses a wiper blade and a wiper assembly for a vehicle which can be adapted to improve the tendency for the wiping edge of the rubber blade to press against the vehicle's windshield and remove the moisture in the presence of a wind stream flowing over the vehicular windshield.

In order to provide a supplemental pressure directing the wiper blade against the windshield in the presence of a wind stream, a wiper blade according to the present invention can be adapted to function as an airfoil or air dam. The resulting airfoil effect enhances the force with which the wiper blade is pressed against the windshield in the presence of higher velocity wind streams. Alternately or concurrently, a portion of the wiper blade assembly restricts the extent to which airflow is applied to the lower portion of the blade, thus reducing the tendency for lift-off to occur.

Another embodiment of the present invention encompasses a flexible wiper blade having a longitudinally extending upper body and a lower, longitudinally extending wiping edge. The wiping edge may be supported as part of the blade by a longitudinally extending edge support portion, and preferably the cross-section is in the shape of an arrowhead.

The edge support portion of the wiper blade encompassed by the present invention may be connected to the upper body by a longitudinally extending neck. A central geometric plane for the wiping edge portion of the wiper blade may be defined as a plane running the length of the blade, which includes both the wiping edge, and the neck portions of the wiper blade when the blade is extended in a straight line without being pressed against a windshield surface. Over a short interval, such a plane also can also be effectively defined in the center portion of a curved blade.

A longitudinally extending stiffener stiffens the flexible wiper blade. The stiffener can be fitted to the blade encompassed by the present invention in numerous ways. According to one aspect of the invention, the upper body portion of the wiper blade has a pair of mounting slots to receive a generally flat, longitudinally extending stiffener. The mounting slots preferably run longitudinally along the main upper body portion along the length of the sides of the wiper blade and therefore are laterally positioned on the wiper blade.

In another embodiment of the present invention, the stiffener has a central, longitudinal, stiffener slot divided into two portions separated by a central bridge joining the two sides of the stiffener. The width of these two stiffener slot portions corresponds to the width of a corresponding, interrupted, “spine” running the length of the rubber blade. This spine within the rubber blade constitutes the separation between the two lateral mounting slots in the blade. The spine of the blade is fitted into the two longitudinal slot portions on the stiffener. The spine is topped by a longitudinal capping strip, divided into two portions, that extend along the top of the rubber blade. The sides of these two capping strips overlie the adjacent surfaces of the stiffener on both sides of the stiffener slot when the blade and stiffener are interengaged, anchoring the parts together.

The respective stiffener slots each have a short widening that will admit a respective portion of the two capping strips, allowing the spine to be slid into place within the stiffener slot for the entire length of the blade.

The stiffener, when mounted with the slots on the wiper blade, is of a width that causes portions of the stiffener to extend outwardly from the sides of the body portion of the wiper blade, or at least on one side. Thus, the sides of the stiffener serve as coupling means in mounting the blade to a wiper arm. Additionally, the one or more outward extending sides of the stiffener provide a surface useful for functioning as an airfoil or air dam.

The stiffener may be mounted to the blade at an inclined angle. In one embodiment, the mounting slots on the blade are inclined at an offset angle from the central geometric plane for the wiping edge by an angle. That is, the angle between the bending plane of the stiffener and the central plane of the wiping edge constitutes an “offset angle”.

The top of the capping strip of the wiper blade, when the stiffener is mounted inter-engaged with the blade body, may be, but not necessarily, slanted, preferably at a similar offset angle from the central geometric plane of the wiping edge.

By providing for one or more of the sides of the stiffener to extend outwardly from the sides of the body portion of the wiper blade, the offset angle of the mounting slots may allow for the face surfaces of such extending side portions, (as well as the top of the capping strip of the wiper blade), to be presented, when mounted on the windshield of a car, so that the protruding face surfaces are more nearly oriented towards the direction the vehicle is traveling. In this configuration, such face surfaces (as well as the top of the upper body portion of the wiper blade) provide the function of an airfoil or an air dam.

By reason of the angled orientation of the stiffener, its lower, leading edge is positioned relatively close to, and preferably evenly spaced from, the surface of the windshield when a wiper according to the invention is installed on a vehicle. This close proximity arises from the inclination of the stiffener. The lower front edge of this angled blade is thereby positioned close to the windshield so that it is prevents the wind stream to enter between the blade and the windshield of the vehicle. Thus, the lower protruding portion of the stiffener serves as an air dam and the tendency for liftoff can be reduced.

In order to enhance the airfoil effect provided by the stiffener, the higher, lateral edges of the stiffener as presented to the wind stream may extend outwardly from the opposite side of the blade. This extension is greater than that found in traditional parallel-sided stiffeners and greater than the extension on the lower side of the blade. The airfoil effect thus provides a force tending to press the wiper against the windshield. This extension of the stiffener's width may be tapered, narrowing towards the ends of the blade and widening towards the center portion.

An increase in widening of the stiffener on the upper side of the blade is practical as there is space above the blade for this widening to occur. While the lower edge of the stiffener is very nearly straight when the wiper when deployed on a flat surface, it may have a slight taper as on the higher side, but preferably to a substantially lesser degree.

To allow a connector to engage a beam blade at its center region, that region of the stiffener may optionally revert to the standard parallel width, permitting the connector to have a width that is closer to the standard width.

In accordance with another embodiment of the present invention, the stiffener is mounted in slots along the sides of the upper body portion of the blade, with the downstream slot being formed in the body at a higher location along the downstream face that on the upstream face that is directed towards the wind stream.

This rearward downstream lateral face of the blade body may be solid, forming one side of a blade upper body having a triangular cross-section. Alternatively, the blade body may contain a longitudinal groove running the length of the blade. The presence of such a groove makes the body of the blade more flexible. Such groove may penetrate into the body of the wiper by approximately one third of its width. The groove may be inwardly tapered with the bottom face of the groove being parallel to the underside surface of the main body portion of the blade, and the top face of the groove being parallel to the inner surface of the lateral slot formed above it.

In one embodiment of the present invention, a connector is provided that connects the wiper blade encompassed by the present invention to the end of a wiper arm. Standard wiper arms generally terminate with a hook and/or transverse pin that extends parallel to the surface of a windscreen. Standard connectors engaging with such hooks/pins present a standard wiper blade to the windshield of a vehicle so that the central plane of the blade is generally upright and perpendicular to such windshield.

However, if a standard connector were used to couple a wiper blade according to the present invention to a wiper arm, then there may be a tendency for the blade edge deflection arising from a wiping action not to be symmetrical. Such a tendency will be resisted by the linkage between the end of the wiper arm and the connector. If this connection is not perfectly rigid some twisting in this coupling may occur. Further, lateral twisting can arise in the flexible body of the wiper blade. Unless the central wiping edge plane of the wiper is generally upright and perpendicular to a windshield, the blade edge deflection will not be held to similar values irrespective whether the blade edge is being wiped in a first or second, reverse direction.

It is therefore desirable for the wiping edge of the wiper blade to be pressed towards the windshield surface in a substantially upright, vertical, direction and preferably so that the pressing force passes through or near to the neck of the blade so as to minimize torque arising at the coupling between the connector and the end of the wiper arm. The wiper blade encompassed by the present invention embodies such an assembly to solve this problem.

Another embodiment of the present invention encompasses a wiper blade assembly, including a connector means for connecting the described wiper blade to a standard wiper arm. In one embodiment, the connector may be asymmetrical. The connector may engage with the wiper blade via the extending sides of the stiffener.

In one embodiment of the present invention, an angled connector is provided that may engage with the blade so that the line of force generated by the pressure of the end of the wiper arm lies within or generally proximate and parallel to the central wiping edge plane of the blade.

When a connector in accordance with an embodiment of the invention is shaped so that the pressing force supplied by the end of the wiper arm is generally directed along or close to the central wiping edge plane of the wiper blade, the tendency for an undesirable torque to generated at the coupling with the wiper arm is reduced and the tendency for an undesirable deflection to occur in the wiping edge is also reduced. Thus, the wiping edge is pressed against the windshield with a balanced pressure which retains the desirable effect of having generally similar amounts of deflection arise irrespective of the direction that the wiper blade is being passed over a vehicle windscreen.

In another embodiment of the present invention, a beam-format wiper is provided, and the stiffener may be in the form of a leaf spring that has a curvature to complement the curvature of a windshield surface. Such a curvature would allow the wiping edge of the wiper blade to bear against the windshield surface with a greater force towards the outer ends of the blade than would occur with a straight blade. With the selection of an appropriate degree of curvature, particularly where the curvature is concentrated in the central portion of the wiper, such a curved beam-format wiper can apply a relatively similar force at the wiping edge over its longitudinal length. The introduction of such an inherent curvature into the stiffener does not interfere with any function encompassed by the present invention.

The wiper blade encompassed by the present invention may be formed of rubber or any other material that is typically used and known to one of ordinary skill in the art.

### BRIEF DESCRIPTION OF THE DRAWINGS

FIG. 1 is a front quarter perspective view of a hood and windshield of a vehicle showing the airflow over the windshield.

FIG. 2 is a side view of a vehicle showing the alignment of a windshield and one embodiment of a wiper blade encompassed by the present invention.

FIG. 2A is an enlarged end view of a wiper blade encompassed by the present invention as oriented for contacting the windshield.

FIG. 3 is a top quarter perspective view of a wiper blade and connector encompassed by the present invention.

FIG. 4 is a perspective view of a wiper blade encompassed by the present invention.

FIG. 5 is a top view of a wiper blade as depicted in FIG. 3.

FIG. 6 is a side view of the wiper blade of FIG. 5 showing a generally constant degree of curvature.

FIG. 6A is a side view of the wiper blade of FIG. 6 wherein the curvature is focused in the center portion of the blade.

FIG. 7 is a side view of the blade of FIG. 3 having the shallow curvature of a blade of FIG. 6 with a connector portion mounted thereto and poised over and above the windshield of a vehicle for engagement there with.

FIG. 8 is a cross-sectional view of the blade of FIG. 4 with a stiffener mounted therein positioned at the orientation of the blade of FIG. 7 to the windshield of a vehicle. The blade is shown without the deflection that would otherwise arise from the pressing force developed by a wiper arm.

FIG. 9A is an alternate and enlarged detail of an alternate connection between the connector and stiffener on one side of the connector.

### DESCRIPTION OF THE EMBODIMENTS

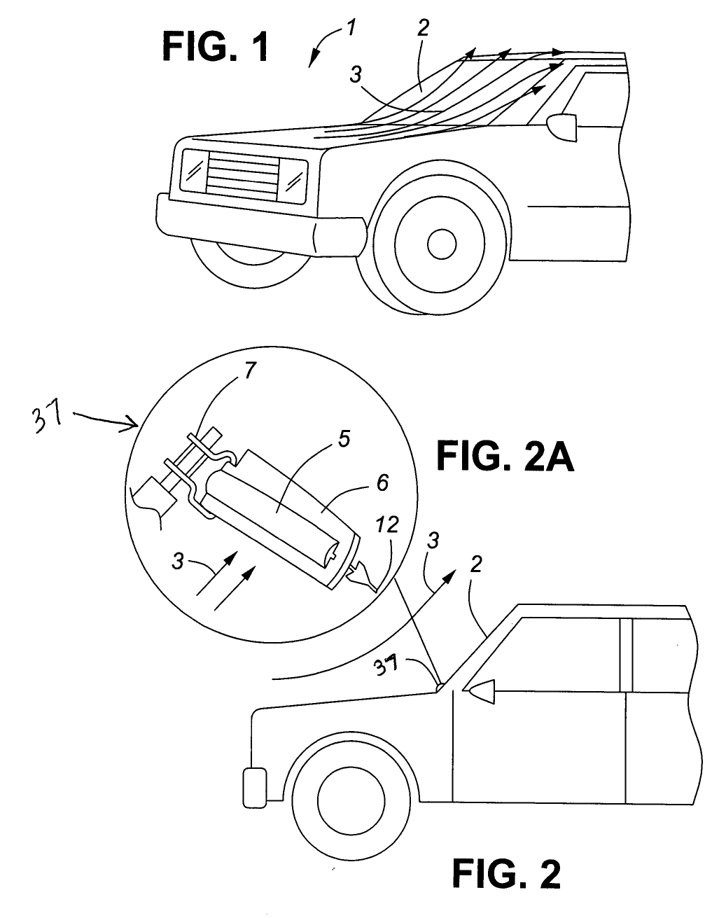

FIG. 1 depicts a vehicle 1 with windshield 2 advancing through airflow 3 whereby airflow 3 is deflected upwardly as it passes over the windshield 2.

FIG. 2 depicts a wiper blade assembly 37 comprising a wiper blade body 5, stiffener 6 and a connector 7. In FIG. 2A, the blade edge 12 is angled with respect to the blade body 5 but is presented to the windshield in an upright orientation.

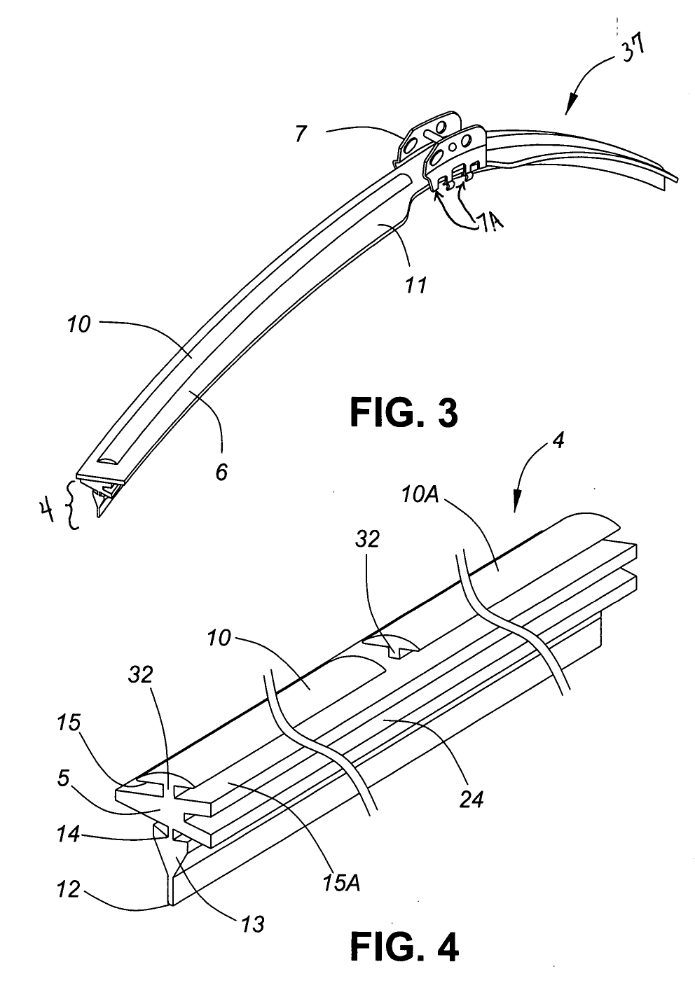

In FIG. 3, one view of the wiper blade assembly 37 is shown. The top surface or capping strip portion 10 of the wiper blade body 5 is shown protruding through the blade surface 6. The bottom portion 7A of the connector 7 is depicted engaging the narrowed portion of the stiffener 6 in the central region of the wiper blade 4. The stiffener 6 is provided with a winged portion 11 on one side which, beyond the narrowing in the center portion, tapers to a smaller width towards the respective outer ends of the wiper blade 4. The wiper blade 4 with the stiffener has a natural, unconstrained curvature as shown in greater detail in FIGS. 6 and 6A. Note that only the blade-connecting portion of the connector 7 is shown. The wiper arm-connecting portion is omitted for clarity.

In FIG. 4, the wiper blade 4, comprises a longitudinally extending body 5 with a capping strip 10 on the top, and provided with a lower, longitudinally extending wiping edge 12. The wiping edge 12 is supported as part of the blade by a longitudinally extending edge support portion 13, generally having the shape in cross-section of an arrowhead. The edge support portion 13 is connected to the body 5 by a longitudinally extending neck 14.

The stiffener 6, when mounted for engagement with the lateral mounting slots 15 on the wiper blade 4, is of a width that causes edge portions of the stiffener 6 to extend outwardly from the sides of the body portion 5 of the wiper blade 4. The outward extending sides of the stiffener 6, particularly in the widened blade portion 11 (see FIG. 3), provide face surfaces areas that are useful in serving the function of an airfoil.

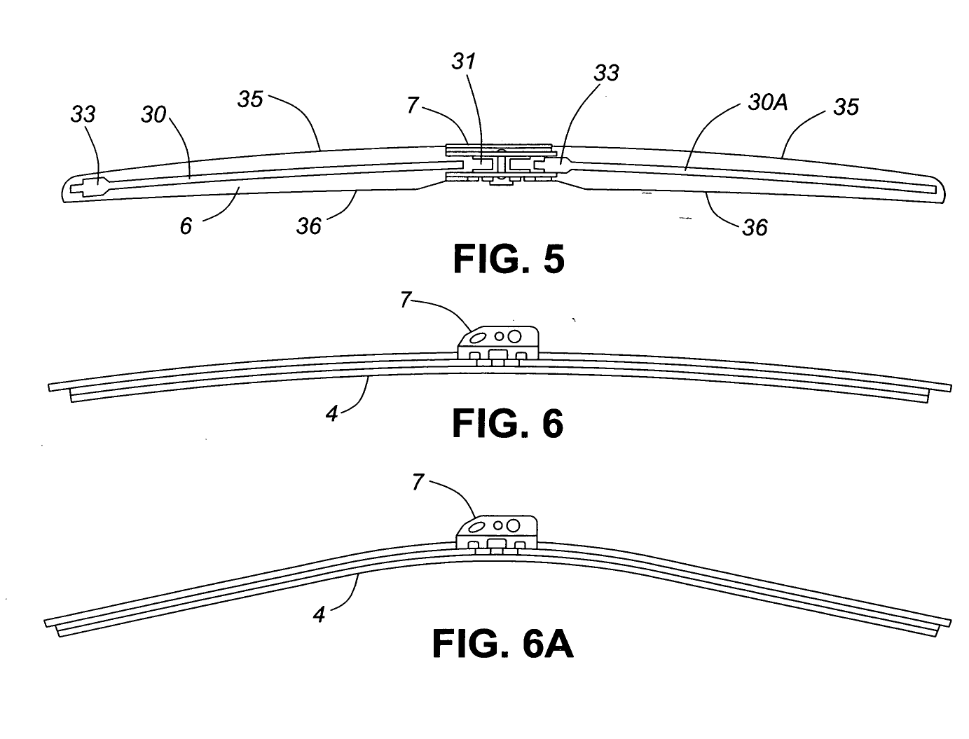

As shown in FIG. 5, the stiffener 6 is fitted to the wiper blade 4 through engagement with a pair of mounting slots 15, 15A formed along the upper portion of the body 5 of the wiper blade 4. The mounting slots 15, 15A generally run longitudinally down the body 5, along the length of the sides of the wiper blade 4. The capping strip 10 of the wiper blade 4 overlies in part the top surface of the stiffener 6, thus joining the parts together. A “spine” 32 extends the length of the wiper blade 4.

The stiffener 6 has a central, longitudinal, stiffener slot 30 divided into two portions 30, 30A separated by a central bridge 31 joining the two sides of the stiffener 6. The width of these two stiffener slot portions 30, 30A corresponds to the width of a corresponding, interrupted, spine 32. The spine 32 within the wiper blade 4 separates the two lateral mounting slots 15, 15A in the wiper blade 4. Further, the spine 32 of the wiper blade 4 is fitted into the two longitudinal slot portions 30, 30A on the stiffener 6 and may be (but does not have to be) interrupted in the center. The connector 7 can further comprise a bridge portion 31. The top capping strip 10 and the spine 32 of the wiper blade 4 may be divided into two sections 10, 10A to accommodate a bridge portion 31 in a connector 7 assembly.

The longitudinally extending stiffener 6 stiffens the flexible wiper blade 4. In the case of the beam-format wiper, the stiffener 6 is preferably in the form of a leaf spring that has a preset curvature to complement the curvature of a windshield surface 2 and to overcome a lack of rigidity in the stiffener 6. This curvature, shown in FIGS. 6 and 6A, allows the wiping edge 12 of the wiper blade 4 to bear against the windshield surface 2 with a greater force towards the outer ends of the blade 4 than would occur with a straight blade. This curvature, as shown in FIG. 6, may be generally even along the length of the blade 4. Or the curvature may be focused to be highest in the central region of the blade 4, as shown in FIG. 6A.

As shown in FIG. 5, the wiper blade 4 can be engaged with the stiffener 6. The respective stiffener slots 30, 30A each may have a short widening 33 that will admit a respective portion of the two capping portions 10, 10A (see FIG. 4), and permit the spine 32 to be slid into place within the stiffener slots 30, 30A along the full length of the wiper blade 4.

Referring to FIG. 8, by reason of the locations and orientations of the slots 15, 15A the stiffener 6 is mounted to the blade body 5 at an inclined angle. The mounting slots 15, 15A may be inclined at an offset angle 16 from the central geometric plane 17, defined as a plane running the length of the wiper blade 37 which includes both the wiping edge 12 and the neck portion 14 of the wiper blade 4 when the wiper blade is extended in a straight line, free from contact with a surface.

The outer top surfaces 19 of the stiffener 6 are offset by a predetermined offset angle 16 from a plane oriented in a 90° orientation. The capping top portion 10 of the wiper blade 4, when the stiffener 6 is mounted along the lateral sides of the blade body 5, may also be slanted similarly.

Because the sides of the stiffener 6 extend outwardly from the sides of the body portion 5 of the wiper blade 4, the offset angle 16 of the mounting slots 15 causes the face surfaces 19 of such extending side portions, (as well as the top capping strip 10 of the body 5 of the wiper blade 4), to be presented, when mounted on the windshield 2 of a car, so that such face surfaces 19 are more nearly oriented towards the direction of the travel of the vehicle. In this configuration, such face surfaces 19 (as well as the top capping strip 10) provide the function of an airfoil.

In one embodiment of the present invention, the offset angle may be between 5° to 45°. In another embodiment, the offset angle may be between 15° and 25°. In yet another embodiment, the offset angle may be 18°.

It is not essential for both sides of the stiffener 6 to be extended to function as an airfoil. The lower, leading edge 35 of the stiffener 6 may be extended so as to be positioned closer to, and preferably evenly spaced from, the surface of the windshield 2 when a wiper according to the invention is installed on a vehicle. This serves to reduce the space for the wind stream 3 to get beneath the blade 4, providing an air dam effect and the limiting tendency for lift-off to occur. While the lower, leading edge 35 of the stiffener 6 may be perfectly straight, it may also incorporate a slight taper, receding from the center portion of the wiper blade 4 when proceeding towards the outer ends of the blade 4.

As can be seen in FIG. 8, the higher, lateral edges 36 of the stiffener 6 as presented to the wind stream may extend outwardly from the opposite side of the blade 4 to a degree that is greater than that found in the traditional parallel-sided stiffeners and greater than the extension in respect of the leading edge 35 of the blade 4. The airfoil effect thereby provided will develop a force tending to press the wiper 4 against the windshield 2. This extension 36 of the stiffener's width may be tapered, narrowing towards the ends of the blade 4 when proceeding outwardly from the center portion.

In accordance with one embodiment of the present invention, the stiffener 6 is mounted in slots 15, 15A along the sides of the body 5 of the wiper blade 4, with the higher, downstream slot 15A being formed in the body 5 along its higher, downstream or rearward side.

This rearward downstream lateral face of the blade body 5 may be solid (not shown), forming one side of a blade body 5 having a triangular cross-section. Alternatively, it may contain a further longitudinal groove 24 running the length of the wiper blade 4. In the latter case, such a groove 24 can reduce the amount of rubber in the main body of the blade, rendering it more flexible.

In another embodiment, the longitudinal groove 24 is inwardly tapered, terminating at a root face at approximately one third of the distance across the body 5 of the wiper blade 4, at approximately the same distance across the body 5 as where the arrowhead 13 will contact the base of the blade body 5 when deflected. This groove 24 introduces additional flexibility into the body 5, reducing shuddering when the blade is passed over a windshield 2.

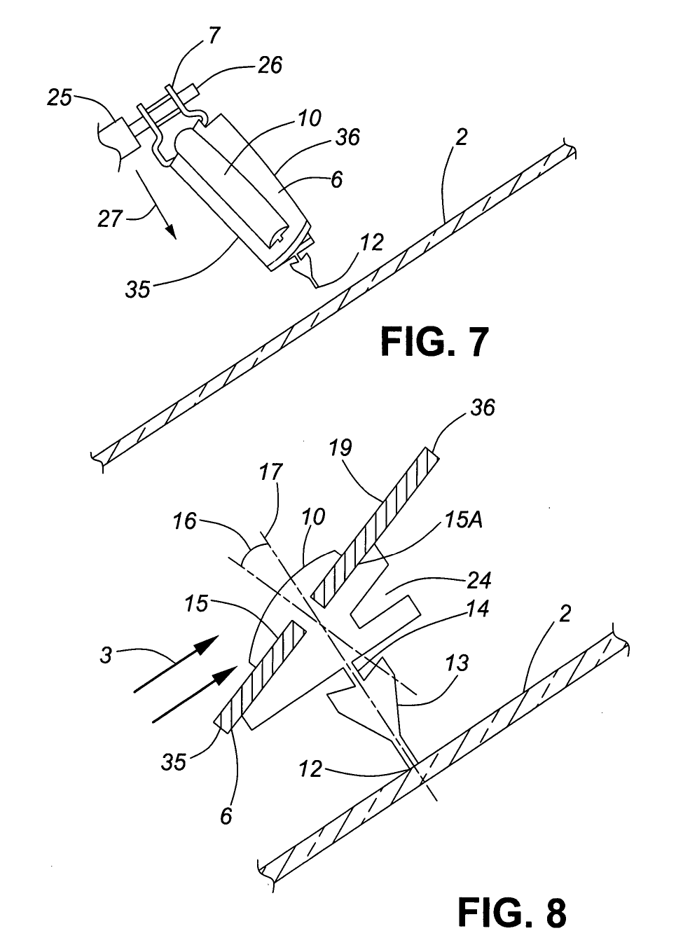

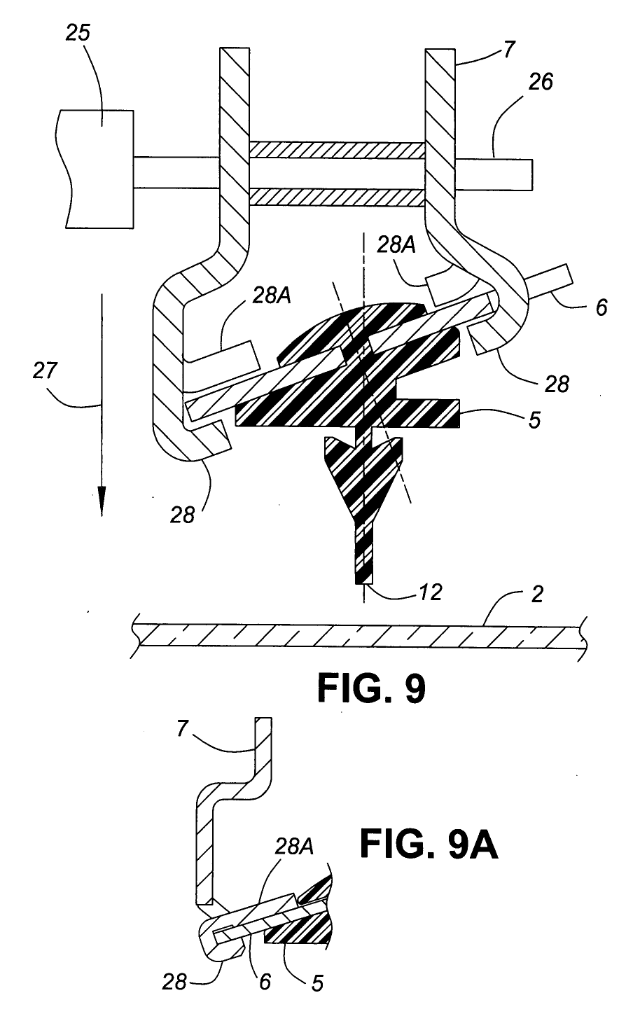

In order to connect the wiper blade 4 to the end of a wiper, a wiper arm 25 is equipped with a pin 26 which engages a connector 7 fastened to the blade 4, as shown in FIGS. 7 and 9. The pressing force of the wiper arm 25 in the direction 27 directs the pin 26 to move in the direction 27. This force is applied to the blade body 5 through the connector 7.

The connector 7 encompassed by the present invention may be asymmetrically shaped to press the wiping edge 12 of the wiper blade 4 towards the windshield surface 2 in a substantially upright, vertical, direction and preferably so that the pressing force 27 passes approximately through the neck 14 and wiping edge 12 of the blade 4, or parallel to that direction, as depicted in FIG. 8. The line of force 27 so generated by the pressure of the end of the wiper arm 25 lies within or generally proximate and parallel to the central plane 17 of the blade 6. To achieve this, the connector 7 is asymmetrically formed so that the central plane 17 of the wiping edge 12 passes approximately through the center of the connector 7 in the same direction as the applied force 27.

As shown in FIG. 9, the connector 7 may engage the wiper blade 4 by connecting to the extending sides of the stiffener 6. Tabs 28, 28A extending from the connector embrace the edges of the stiffener 6 fixing the connector 7 in place. The asymmetry in the connector 7 is adjusted to cancel the effect of the asymmetry in the orientation of the stiffener 6 within the wiper blade 4. The combination serves to present the wiping edge 14 of the wiper blade 4 to a windshield 2 with a normal, substantially upright, vertical, orientation in the absence of deflection arising from wiper arm pressure.

When a connector 7 in accordance with a preferred variant of the invention is shaped so that the pressing force supplied by the end of the wiper arm 25 is generally directed along the central plane 17 of the wiper blade, this reduces the tendency for an undesirable torque to be applied to the portion 13 of the wiper blade supporting the wiping edge 12. Accordingly, the wiping edge 12 is pressed against the windshield 2 with a balanced pressure which retains the desirable effect of having similar amounts of deflection arise irrespective of the direction that the wiper blade 4 is being passed over a vehicle windscreen. This arises because any tendency for the force 27 to develop a twisting torque about the blade body 5 is minimized.

It is contemplated that one of ordinary skill in the art may make numerous modifications to the wiper blade and wiper blade assembly of the present invention without departing from the spirit and scope of the invention as defined in the following claims.

I claim:

1. A windshield wiper blade assembly comprising:
a flexible blade body having an upper body portion and a lower wiping edge portion, where said wiping edge portion is supported from the body portion by an edge support portion, the edge support portion being connected to the body portion through a neck portion,
a pair of lateral longitudinal mounting slots,
a stiffener engaged with said mounting slots, and
wherein the mounting slots are inclined at an offset angle from the central geometric plane of the blade.

2. The windshield wiper blade assembly of claim 1, wherein the stiffener has two top face surface portions that protrude outwardly from both of the lateral sides of the wiper blade.

3. The windshield wiper blade assembly of claim 1, wherein the upper body portion has a top surface, and where the top surface is generally parallel with a top face surface portion of the stiffener.

4. The windshield wiper blade assembly of claim 2, wherein at least one edge of the extending face surfaces of the stiffener is tapered and narrows towards the end of the blade.

5. The windshield wiper blade assembly of claim 1, wherein a lateral side of the stiffener is more narrow at a center portion of the wiper blade than on either side of such center portion.

6. The windshield wiper blade assembly of claim 1, wherein the upper body portion of the wiper blade has a rearward, downstream lateral face with a longitudinal groove formed in said rearward face, running the length of the blade.

7. The windshield wiper blade of claim 1, wherein orientation of the stiffener at an offset angle from the central geometric plane of the blade defines an asymmetry in the blade, the wiping blade being in combination with a connector for engagement to the end of a wiper arm on a motor vehicle, wherein the connector engages the wiper blade by connecting to the extending sides of the stiffener, the connector being asymmetrically formed to cancel the effect of the asymmetry in the orientation of the stiffener within the wiper blade so as to present the wiping edge of the wiper blade, when coupled to the wiper arm, to a windshield with a normal, substantially upright, vertical, orientation with the central plane of the wiper in a generally upright orientation with respect to the windshield.

8. The windshield wiper blade of claim 1, further comprising a connector means for engagement to the end of a wiper arm on a motor vehicle, wherein the connector engages the wiper blade by connecting to the extending sides of the stiffener, the connector being geometrically formed to engage the blade so that the line of force generated by the pressure of the end of a wiper arm on a vehicle windshield in the central portion of the blade and lies within or generally proximate and parallel to the central plane of the blade.

9. The windshield wiper blade of claim 1, wherein the stiffener is in the form of a leaf spring that has a preset curvature intended to complement the curvature of a windshield surface and to overcome a lack of rigidity in the stiffener, such curvature being greater towards the central portion of the wiper blade than on either side of the central portion.

10. A rubber blade for a wiper having a frame supporting the rubber blade that closely contacts a surface of an automotive windshield and being attached to a wiper arm for pressing and operating the wiper against and across the windshield via an adapter, and a tension spring having a predetermined tension and inserted along a mounting slot of the rubber blade for evenly distributing load along the blade onto the windshield, the rubber blade comprising: a head portion forming an upper portion of the rubber blade and including a mounting slot for mounting the rubber blade to the frame, the mounting slot being inclined at an offset angle dependant on a position of the frame such that a normal line of a cross section of the mounting slot is offset by a predetermined angle from a vertical axis of the rubber blade; and a wiping portion forming a lower portion of the rubber blade for contacting the windshield, the wiping portion being disposed in a direction of the vertical axis.

11. The wiper of claim 10, further comprising an air pocket disposed on an upper side of the rubber blade for imparting added deforming and recovering elasticity thereto.

12. A wiper frame having a predetermined resilience and a slot formed therein and coupled through an adaptor to a wiper arm, the wiper frame for supporting and pressing a rubber blade on a windshield surface, characterized in that the wiper arm moves the rubber blade across the windshield surface, the slot guides a sliding insert formed in a mounting portion at an upper end of the rubber blade for distributing a load from the wiper arm evenly across the rubber blade, the mounting portion is disposed at a predetermined angle against the wiper frame and supports a wiping portion forming a contact surface at a bottom end of the rubber blade, the slot is formed in a position such that a pressure of the wiper arm falls at a center point of the wiping portion, the slot allows the wiping portion to apply vertical force on and contact the windshield surface by being mounted on the frame through the mounting portion, and the slot creates a predetermined offset between centers of the mounting portion and the wiping portion.

13. The wiper frame according to claim 12, wherein the slot is formed in a symmetric shape about a center of the wiper frame.

14. The wiper frame according to claim 12, wherein the slot is formed with a curvature that curves gently toward both ends thereof.

15. A rubber blade of a wiper mounted to a frame with a predetermined elasticity, characterized in that the frame evenly distributes a load along the rubber blade onto a windshield surface, the frame is coupled through an adapter to a wiper arm and presses the rubber blade against the windshield surface to simultaneously move the rubber blade across the windshield surface, the rubber blade has a sliding insert into which the frame is installed, the rubber blade has a top that is slanted and installed at a predetermined angle at a mounting portion of the rubber blade with respect to the frame, a lower end of the rubber blade has a wiping portion extending from the mounting portion and including a contact surface contacting the windshield surface, the mounting portion and the wiping portion are formed such that respective centers thereof are offset from one another by a predetermined distance such that a pressing force of the wiper arm passes through the center of the wiping portion.

16. The rubber blade according to claim 15, wherein the offset distance is a distance between the center of the mounting portion and the center of the wiping portion.

17. The rubber blade according to claim 15, wherein the pressing force passes between the center of the wiping portion and the contact point through the offset.

18. An automotive wiper having a frame supporting a blade that closely contacts a surface of an automotive windshield and being attached to a wiper arm for pressing and operating the wiper against and across the windshield via an adapter, and a tension spring having a predetermined tension and inserted along a rail portion of the blade for evenly distributing load along the blade onto the windshield, wherein the automotive wiper comprises: an adapter disposed perpendicularly to a longitudinal axis of the frame at a central portion thereof for a wiper arm to mount to, the frame being offset by an angle θ from a horizontal axis taken at a sectional view of the wiper with respect to the adapter, whereby the frame is offset by an adjustable angle θ1 from a perpendicular axis due to an offset of the frame and the adapter when the blade is pressed in its entirety against the automotive windshield.

19. The wiper of claim 18, wherein the frame includes a leading edge that is disposed closer to the windshield than a trailing edge of the frame when the frame is pressed against the windshield, whereby the adapter and frame are selectively positioned at an offset angle of between 5° to 50° with respect to a vertical axis.

20. An automotive wiper having a frame supporting a blade that closely contacts a surface of an automotive windshield and being attached to a wiper arm for pressing and operating the wiper against and across the windshield via an adapter, and a tension spring having a predetermined tension and inserted along a rail portion of the blade for evenly distributing load along the blade onto the windshield, wherein the automotive wiper comprises: a tensile member formed along one piece and extending symmetrically to both ends thereof from a central portion, the tensile member being both a single one-piece tension spring and a skeletal structure for mounting to a wiper arm; and an adapter disposed perpendicularly to a longitudinal axis of the tensile member at a central portion thereof for the wiper arm to mount to, the tensile member being offset by an angle θ from a horizontal axis taken at a sectional view of the wiper with respect to the adapter, whereby the tensile member is offset by an adjustable angle θ1 from a perpendicular axis due to an offset of the tensile member and the adapter when the blade is pressed in its entirety against the automotive windshield.

21. The automotive wiper of claim 20, wherein the tensile member includes a leading edge that is disposed closer to the windshield than a trailing edge of the tensile member when the tensile member is pressed against the windshield, whereby the adapter and tensile member are selectively positioned at an offset angle of between 5° to 50° with respect to a vertical axis.

22. The automotive wiper of claim 20, wherein the tensile member narrows toward each end thereof and has a recess at a central portion thereof for reducing negative pressure.

23. The automotive wiper of claim 20, wherein the blade mounted to the tensile member is laterally asymmetrical and offset from a vertical axis according to the offset angle of the tensile member.

24. The automotive wiper of claim 20, wherein the blade is curved and attached to the tensile member for maintaining a substantially vertical disposition of the blade with respect to the windshield and close contact with the windshield.

25. An automotive wiper having a frame supporting a blade that closely contacts a surface of an automotive windshield and being attached to a wiper arm for pressing and operating the wiper against and across the windshield via an adapter, and a tension spring having a predetermined tension and inserted along a rail portion of the blade for evenly distributing load along the blade onto the windshield, wherein the automotive wiper comprises: a tensile member formed along one piece and extending symmetrically to both ends thereof from a central portion, the tensile member being both a single one-piece tension spring and a skeletal structure for mounting to the wiper arm; and an adapter disposed perpendicularly to a longitudinal axis of the tensile member at a central portion thereof for the wiper arm to mount to, the tensile member being offset by an angle .theta. from a horizontal axis taken at a sectional view of the wiper with respect to the adapter, whereby the tensile member is offset by an adjustable angle θ1 from a perpendicular axis due to an offset of the tensile member and the adapter when the blade is pressed in its entirety against the automotive windshield, and whereby the blade is curved to deviate by an angle θ2 from a longitudinal axis thereof for maintaining a substantially perpendicular angle with respect to the windshield and close contact with the windshield, despite being offset from a vertical axis thereof in conjunction with the tensile member.

26. The automotive wiper of claim 25, wherein the tensile member that is a single piece wiper frame includes a leading edge that is disposed closer to the windshield than a trailing edge of the tensile member when the tensile member is pressed against the windshield, whereby the adapter and tensile member are selectively positioned at an offset angle of between 5° to 50° with respect to a vertical axis.

27. The automotive wiper of claim 25, wherein the tensile member narrows toward each end thereof and has a recess at a central portion thereof where the adapter is located.

28. A windshield wiper blade comprising:
a rounded top portion,
a central body portion, and
a wiping edge portion,
wherein the rounded top portion is connected to the central body portion via a first neck portion,
wherein the central body portion is connected to the wiping edge portion via a second neck portion,
wherein the central body portion has a pair of mounting slots, and
the wiping edge is in the shape of an arrow.

29. The windshield wiper blade of claim 28, wherein said blade is made of a rubber material.
